(19) United States
(12) Patent Application Publication
(10) Pub. No.: US 2018/0173692 A1
(43) Pub. Date: Jun. 21, 2018

(54) ICONOGRAPHIC SYMBOL PREDICTIONS FOR A CONVERSATION

(71) Applicant: Google Inc., Mountain View, CA (US)

(72) Inventors: Alexa Greenberg, San Francisco, CA (US); Sebastian Millius, Zurich (CH); Matthew Sharifi, Kilchberg (CH)

(21) Appl. No.: 15/383,753

(22) Filed: Dec. 19, 2016

(51) Int. Cl. G06F 17/27; G06T 11/60; G06F 3/0481; G06F 3/0488; G06F 3/0484

(52) U.S. Cl. CPC G06F 17/276; G06T 11/60; G06F 3/04842; G06F 3/04886; G06F 3/04817

(57) ABSTRACT

A computing device is described that outputs, for display, a graphical keyboard comprising a plurality of keys, determines, based at least in part on an indication of a selection of one or more keys from the plurality of keys, text of an electronic communication, and determines, based at least in part on the text, an implied user-expression that characterizes at least a portion of the text. The computing device generates a phrase of one or more iconographic symbols that represent the implied user-expression, and outputs, for display within the graphical keyboard, a graphical indication of the phrase.

### BACKGROUND

Despite being able to simultaneously execute several applications, some mobile computing devices can only present a graphical user interface (GUI) of a single application at a time. A user of a mobile computing device may have to provide input to switch between different application GUIs to complete a particular task. For example, a user of a mobile computing device may have to cease entering text in a messaging application, provide input to cause the device to toggle to a search application, and provide yet additional input at a GUI of the search application to search for a particular piece of information, such as an iconographic symbol (e.g., an emoji symbol), that the user may want to use to finish composing a message or otherwise entering text in the messaging application. Providing several inputs required by some computing devices to perform various tasks can be tedious, repetitive, and time consuming.

### SUMMARY

In general, this disclosure is directed to techniques for enabling a computing device to automatically predict a phrase of one or more iconographic symbols that represent an implied-user expression inferred based at least in part on text being entered with a graphical keyboard and display the predicted phrase within the graphical keyboard. For example, a user may interact with a graphical keyboard that is presented, by a keyboard application, at a presence-sensitive screen (e.g., a touchscreen). The interaction may be in association with a communication application, for example a messaging application, a texting application, or the like. The computing device may detect user input associated with the graphical keyboard as the user types a message as part of an electronic conversation. The keyboard application identifies, based on the words of the electronic conversation, identifies a user-expression, feeling, sentiment, or other implied message or emotion that is not literally captured by the words of the electronic conversation. In other words, the keyboard application may characterize a portion of the electronic conversation.

The keyboard application may automatically generate and display a suggested phrase of one or more iconographic symbols that characterizes the electronic conversation but is not literally expressed by the words being used in the electronic conversation. The user may select the suggested phrase thereby causing the keyboard application to insert and/or send the iconographic symbol phrase as a new, or part of an existing message. In some examples, the computing device may present the suggested phrase as part of or in place of a portion of the keyboard (e.g., in place of a suggested word within a word-suggestion region of the graphical keyboard).

By providing a GUI that includes a graphical keyboard with integrated iconographic symbol phrase prediction, an example computing device may provide a way for a user to quickly obtain suggested iconographic symbol phrases that are relevant to input that the user has already provided at the graphical keyboard without having to switch between several different applications and application GUIs, re-type text already input at the graphical keyboard, or come up with a relevant iconographic symbol phrase on his or her own. In this way, techniques of this disclosure may reduce the amount of time and the number of user inputs required to obtain iconographic symbol phrases, which may simplify the user experience and may reduce power consumption of the computing device.

In one example, a method is described that includes outputting, by a keyboard application executing at a computing device, for display, a graphical keyboard comprising a plurality of keys, determining, by the keyboard application, based at least in part on an indication of a selection of one or more keys from the plurality of keys, text of an electronic communication, and determining, by the keyboard application, based at least in part on the text, an implied user-expression that characterizes at least a portion of the text. The method further includes generating, by the keyboard application, a phrase of one or more iconographic symbols that represent the implied user-expression, and outputting, by the keyboard application, for display within the graphical keyboard, a graphical indication of the phrase.

In another example, a computing device is described that includes a presence-sensitive display component, at least one processor, and a memory. The memory stores instructions associated with a keyboard application that when executed cause the at least one processor to: output, for display at the presence-sensitive display component, a graphical keyboard comprising a plurality of keys, and determine, based at least in part on an indication of a selection of one or more keys from the plurality of keys, text of an electronic communication. The instructions, when executed, further cause the at least one processor to determine, based at least in part on the text, an implied user-expression that characterizes at least a portion of the text, generate, a phrase of one or more iconographic symbols that represent the implied user-expression, and output, for display within the graphical keyboard, a graphical indication of the phrase.

In another example, a computer-readable storage medium is described that includes instructions that when executed cause at least one processor of a computing device to output, for display, a graphical keyboard comprising a plurality of keys, and determine, based at least in part on an indication of a selection of one or more keys from the plurality of keys, text of an electronic communication. The instructions, when executed, further cause the at least one processor to determine, based at least in part on the text, an implied user-expression that characterizes at least a portion of the text, generate, a phrase of one or more iconographic symbols that represent the implied user-expression, and output, for display within the graphical keyboard, a graphical indication of the phrase.

In another example, a computing system is described that includes means for outputting, for display, a graphical keyboard comprising a plurality of keys, means for determining, based at least in part on an indication of a selection of one or more keys from the plurality of keys, text of an electronic communication, and means for determining, based at least in part on the text, an implied user-expression that characterizes at least a portion of the text. The computing system further includes means for generating a phrase of one or more iconographic symbols that represent the implied user-expression, and means for outputting, for display within the graphical keyboard, a graphical indication of the phrase.

The details of one or more examples are set forth in the accompanying drawings and the description below. Other features, objects, and advantages of the disclosure will be apparent from the description and drawings, and from the claims.

### BRIEF DESCRIPTION OF DRAWINGS

FIG. 1 is a conceptual diagram illustrating an example computing device that is configured to present a graphical keyboard with integrated iconographic symbol based predictions, in accordance with one or more aspects of the present disclosure.

FIG. 2 is a block diagram illustrating an example computing device that is configured to present a graphical keyboard with integrated iconographic symbol based predictions, in accordance with one or more aspects of the present disclosure.

FIG. 3 is a block diagram illustrating an example computing device that outputs graphical content for display at a remote device, in accordance with one or more techniques of the present disclosure.

FIGS. 4A-4E are conceptual diagrams illustrating example graphical user interfaces of an example computing device that is configured to present a graphical keyboard with integrated iconographic symbol based predictions, in accordance with one or more aspects of the present disclosure.

FIG. 5 is a flowchart illustrating example operations of a computing device that is configured to present a graphical keyboard with integrated iconographic symbol based predictions, in accordance with one or more aspects of the present disclosure.

### DETAILED DESCRIPTION

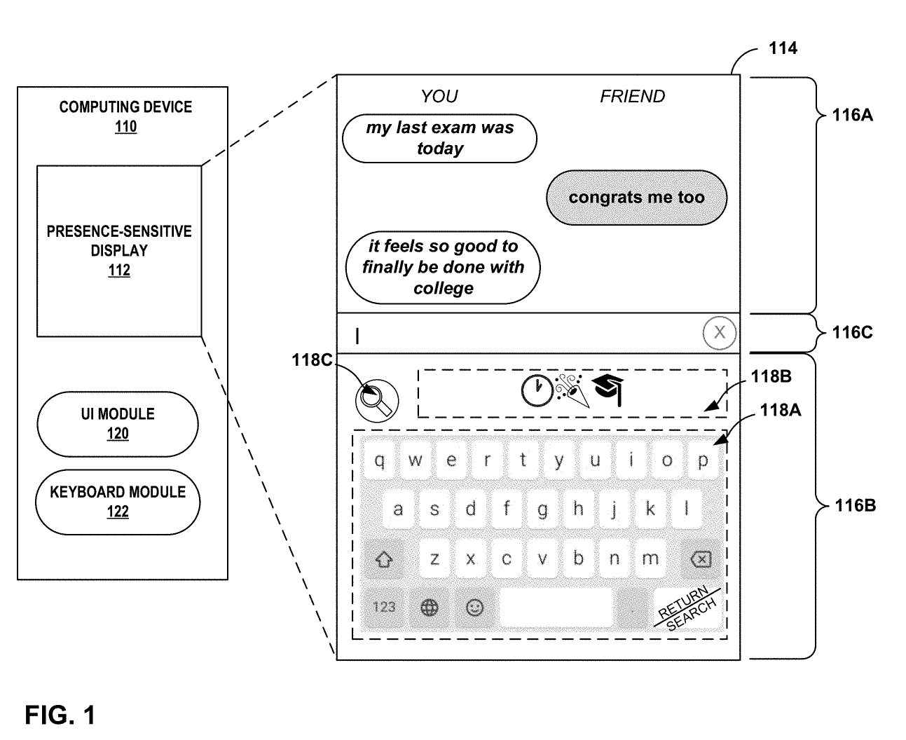

FIG. 1 is a conceptual diagram illustrating an example computing device 110 that is configured to present a graphical keyboard with integrated iconographic symbol based predictions, in accordance with one or more aspects of the present disclosure. While primarily described below with respect to emoji symbol phrases, the techniques of this disclosure are equally applicable to other types of iconographic symbol phrases. Some examples of iconographic symbols include, but are not necessarily limited to, emoji symbols, ASCII emoticons, special ASCII symbols, dynamic and static images, stickers, and the like.

Computing device 110 may represent a mobile device, such as a smart phone, a tablet computer, a laptop computer, computerized watch, computerized eyewear, computerized gloves, or any other type of portable computing device. Additional examples of computing device 110 include desktop computers, televisions, personal digital assistants (PDA), portable gaming systems, media players, e-book readers, mobile television platforms, automobile navigation and entertainment systems, vehicle (e.g., automobile, aircraft, or other vehicle) cockpit displays, or any other types of wearable and non-wearable, mobile or non-mobile computing devices that may output a graphical keyboard for display.

Computing device 110 includes a presence-sensitive display (PSD) 112, user interface (UI) module 120 and keyboard module 122. Modules 120 and 122 may perform operations described using software, hardware, firmware, or a mixture of hardware, software, and firmware residing in and/or executing at computing device 110. One or more processors of computing device 110 may execute instructions that are stored at a memory or other non-transitory storage medium of computing device 110 to perform the operations of modules 120 and 122.

Computing device 110 may execute modules 120 and 122 as virtual machines executing on underlying hardware. Modules 120 and 122 may execute as one or more services of an operating system or computing platform. Modules 120 and 122 may execute as one or more executable programs at an application layer of a computing platform.

PSD 112 of computing device 110 may function as respective input and/or output devices for computing device 110. PSD 112 may be implemented using various technologies. For instance, PSD 112 may function as input devices using presence-sensitive input screens, such as resistive touchscreens, surface acoustic wave touchscreens, capacitive touchscreens, projective capacitance touchscreens, pressure sensitive screens, acoustic pulse recognition touchscreens, or another presence-sensitive display technology. PSD 112 may also function as output (e.g., display) devices using any one or more display devices, such as liquid crystal displays (LCD), dot matrix displays, light emitting diode (LED) displays, organic light-emitting diode (OLED) displays, e-ink, or similar monochrome or color displays capable of outputting visible information to a user of computing device 110.

PSD 112 may detect input (e.g., touch and non-touch input) from a user of respective computing device 110. PSD 112 may detect indications of input by detecting one or more gestures from a user (e.g., the user touching, pointing, and/or swiping at or near one or more locations of PSD 112 with a finger or a stylus pen). PSD 112 may output information to a user in the form of a user interface (e.g., user interface 114), which may be associated with functionality provided by computing device 110. Such user interfaces may be associated with computing platforms, operating systems, applications, and/or services executing at or accessible from computing device 110 (e.g., electronic message applications, chat applications, Internet browser applications, mobile or desktop operating systems, social media applications, electronic games, and other types of applications). For example, PSD 112 may present user interface 114 which, as shown in FIG. 1, is a graphical user interface of a chat application executing at computing device 110 and includes various graphical elements displayed at various locations of PSD 112.

As shown in FIG. 1, user interface 114 is a chat user interface. However, user interface 114 may be any graphical user interface which includes a graphical keyboard. User interface 114 includes output region 116A, graphical keyboard 116B, and edit region 116C. A user of computing device 110 may provide input at graphical keyboard 116B to produce characters within edit region 116C that form the content of the electronic messages displayed within output region 116A. The messages displayed within output region 116A form a chat conversation between a user of computing device 110 and a user of a different computing device.

UI module 120 manages user interactions with PSD 112 and other components of computing device 110. In other words, UI module 120 may act as an intermediary between various components of computing device 110 to make determinations based on user input detected by PSD 112 and generate output at PSD 112 in response to the user input. UI module 120 may receive instructions from an application, service, platform, or other module of computing device 110 to cause PSD 112 to output a user interface (e.g., user interface 114). UI module 120 may manage inputs received by computing device 110 as a user views and interacts with the user interface presented at PSD 112 and update the user interface in response to receiving additional instructions from the application, service, platform, or other module of computing device 110 that is processing the user input.

Keyboard module 122 represents an application, service, or component executing at or accessible to computing device 110 that provides computing device 110 with a graphical keyboard having integrated search features including iconographic symbol phrase prediction. Keyboard module 122 may switch between operating in text-entry mode in which keyboard module 122 functions similar to a traditional graphical keyboard, or search mode in which keyboard module 122 performs various integrated search functions, iconographic symbol phrase predictions, or interfaces with one or more search and prediction based search applications or functionality.

In some examples, keyboard module 122 may be a stand-alone application, service, or module executing at computing device 110 and, in other examples, keyboard module 122 may be a sub-component, such as an extension, acting as a service for other applications or device functionality. For example, keyboard module 122 may be integrated into a chat or messaging application executing at computing device 110 whereas, in other examples, keyboard module 122 may be a stand-alone application or subroutine that is invoked by an application or operating platform of computing device 110 any time an application or operating platform requires graphical keyboard input functionality. Keyboard module 122 may be a keyboard extension that operates as a sub-component of a stand-alone keyboard application. In some examples, computing device 110 may download and install keyboard module 122 from an application or application extension repository of a service provider (e.g., via the Internet). In other examples, keyboard module 122 may be preloaded during production of computing device 110.

When operating in text-entry mode, keyboard module 122 of computing device 110 may perform traditional, graphical keyboard operations used for text-entry, such as: generating a graphical keyboard layout for display at PSD 112, mapping detected inputs at PSD 112 to selections of graphical keys, determining characters based on selected keys, or predicting or autocorrecting words and/or textual phrases based on the characters determined from selected keys.

Graphical keyboard 116B includes graphical elements displayed as graphical keys 118A. Keyboard module 122 may output information to UI module 120 that specifies the layout of graphical keyboard 116B within user interface 114. For example, the information may include instructions that specify locations, sizes, colors, and other characteristics of graphical keys 118A. Based on the information received from keyboard module 122, UI module 120 may cause PSD 112 to display graphical keyboard 116B as part of user interface 114.

Each key of graphical keys 118A may be associated with one or more respective characters (e.g., a letter, number, punctuation, or other character) displayed within the key. A user of computing device 110 may provide input at locations of PSD 112 at which one or more of graphical keys 118A are displayed to input content (e.g., characters, iconographic symbol phrase predictions, etc.) into edit region 116C (e.g., for composing messages that are sent and displayed within output region 116A or for inputting a search query that computing device 110 executes from within graphical keyboard 116B). Keyboard module 122 may receive information from UI module 120 indicating locations associated with input detected by PSD 112 that are relative to the locations of each of the graphical keys. Using a spatial and/or language model, keyboard module 122 may translate the inputs to selections of keys and characters, words, and/or phrases.

For example, PSD 112 may detect user inputs as a user of computing device 110 provides the user inputs at or near a location of PSD 112 where PSD 112 presents graphical keys 118A. The user may type at graphical keys 118A to enter the phrase “it feels so good to finally be done with college” at edit region 116C. UI module 120 may receive, from PSD 112, an indication of the user input detected by PSD 112 and output, to keyboard module 122, information about the user input. Information about the user input may include an indication of one or more touch events (e.g., locations and other information about the input) detected by PSD 112.

Based on the information received from UI module 120, keyboard module 122 may map detected inputs at PSD 112 to selections of graphical keys 118A, determine characters based on selected keys 118A, and predict or autocorrect words and/or phrases determined based on the characters associated with the selected keys 118A. For example, keyboard module 122 may include a spatial model that may determine, based on the locations of keys 118A and the information about the input, the most likely one or more keys 118A being selected are the keys. Responsive to determining the most likely one or more keys 118A being selected, keyboard module 122 may determine one or more characters, words, and/or phrases. For example, each of the one or more keys 118A being selected from a user input at PSD 112 may represent an individual character or a keyboard operation. Keyboard module 122 may determine a sequence of characters selected based on the one or more selected keys 118A. In some examples, keyboard module 122 may apply a language model to the sequence of characters to determine one or more the most likely candidate letters, morphemes, words, and/or phrases that a user is trying to input based on the selection of keys 118A. In the example of FIG. 1, keyboard module 122 may determine the sequence of characters corresponds to the letters of the phrase it feels so good to finally be done with college”.

Keyboard module 122 may send the sequence of characters and/or candidate words and phrases (e.g., “it feels so good to finally be done with college”) to UI module 120 and UI module 120 may cause PSD 112 to present the characters and/or candidate words determined from a selection of one or more keys 118A as text within edit region 116C. In some examples, when functioning as a traditional keyboard for performing text-entry operations, and in response to receiving a user input at graphical keys 118A (e.g., as a user is typing at graphical keyboard 116B to enter text within edit region 116C), keyboard module 122 may cause UI module 120 to display the candidate words and/or phrases as one or more selectable spelling corrections and/or selectable word or phrase suggestions within suggestion region 118B.

In addition to performing traditional, graphical keyboard operations used for text-entry, keyboard module 122 of computing device 110 also provides integrated search capability, including iconographic symbol phrase prediction. That is, rather than requiring a user of computing device 110 to navigate away from user interface 114 which provides graphical keyboard 116B (e.g., to a different application or service executing at or accessible from computing device 110) to cause computing device 110 to perform a search function, keyboard module 122 may operate in search mode in which keyboard module 122 may execute searches, make predictions, recommend search queries, images, stickers, and iconographic symbol phrases based on text being entered at graphical keyboard 116B, and present search results, predictions, and recommendations at one or more possible locations and formats, such as results within the same region of PSD 112 at which graphical keyboard 116B is displayed.

As indicated above, keyboard module 122 may execute as a stand-alone application, service, or module executing at computing device 110 or as a single, integrated sub-component thereof. Therefore, if keyboard module 122 forms part of a chat or messaging application executing at computing device 110, keyboard module 122 may provide the chat or messaging application with text-entry capability as well as search capability. Similarly, if keyboard module 122 is a stand-alone application or subroutine that is invoked by an application or operating platform of computing device 110 any time an application or operating platform requires graphical keyboard input functionality, keyboard module 122 may provide the invoking application or operating platform with text-entry capability as well as search capability.

In some examples, when operating in search mode, keyboard module 122 may cause graphical keyboard 116B to include search element 118C. Search element 118C represents a selectable element (e.g., an icon, an image, a keyboard key, or other graphical element) of graphical keyboard 116B for manually invoking one or more of the various search features of graphical keyboard 116B. For example, by selecting search element 118C (e.g., by tapping or gesturing at a location or within a region of PSD 112 at which search element 118C is displayed), a user can cause computing device 110 to display a predicted phrase of one or more iconographic symbols that may be relevant to text of an electronic communication without the user having to expressly navigate to a separate application, service, or other feature executing at or accessible from computing device 110.

In some examples, search element 118C may be used as an indicator of a status associated with a search or prediction feature. For instance, if keyboard module 122 predicts a phrase of one or more iconographic symbols that may be relevant to text of an electronic communication, keyboard module 122 may cause search element 118C to flash, pulse, change color, move, or perform some other animation to indicate that the iconographic symbol phrase was identified. In some examples, keyboard module 122 may cause search element 118C to morph into an iconographic symbol icon (e.g., an emoji icon), as opposed to a non-iconographic symbol icon (e.g., a magnifying glass icon) to indicate that the phrase of one or more iconographic symbols was identified as opposed to indicating that a search query or other prediction was identified.

When operating in search mode, keyboard module 122 may automatically execute various search functions whether or not graphical keyboard 116B includes search element 118C. For example, keyboard module 122 may predict a search query, recommend a phrase of one or more iconographic symbols, or generate other suggested content based on text keyboard module 122 infers from user input and from other information obtained by computing device 110, and display the suggested content within graphical keyboard 16B. For example, keyboard module 122 may configure suggestion region 118B to present suggested content (e.g., predicted phrases of one or more iconographic symbols) as selectable elements within search element 118C instead of, or in addition to, predicted characters, textual words, textual phrases, or other primarily linguistic information that keyboard module 122 derives from a language model, lexicon, or dictionary. In other words, rather than just providing spelling or word suggestions from a dictionary within suggestion region 118B, computing device 110 may include, within suggestion region 118B, suggested search related content in addition to or in place of suggested textual content, that computing device 110 (or other device in conjunction or communication with device 110) determines may assist a user, at a current time (e.g., when providing input related to electronic communications).

Keyboard module 122 may perform automatic prediction of user-expressions that characterize at least a portion of text of electronic communications and/or text being input using graphical keyboard 116B. For example, keyboard module 122 may infer a user-expression that is implied by the text but not necessarily stated in the text. From the implied user-expression, keyboard module 122 may generate a phrase of one or more iconographic symbols that represent the implied user-expression. In this way, keyboard module 122 may enable computing device 110 to provide a way for a user to quickly obtain a phrase of one or more iconographic symbols that is relevant (but not necessarily a direct replacement) to the input that the user has already provided at graphical keyboard 116B, without having to switch between several different applications or application GUIs, re-type text already input at graphical keyboard 116B, or come up with a relevant iconographic symbol phrase on his or her own.

Keyboard module 122 may automatically generate and display a graphical indication of a generated phrase (e.g., at suggestion region 118B or as graphical element 118C). If the user is interested in using the phrase of one or more iconographic symbols (e.g., by sending the phrase as part of an electronic communication), the user can optionally provide input at a location of PSD 112 at which the indication of the phrase is displayed that selects the phrase and causes keyboard module 122 to input the phrase into edit region 116C or send the phrase as part of an electronic communication. In some examples, keyboard module 122 may cause UI module 120 and PSD 112 to present the phrase in place of a portion of graphical keys 118A.

To help illustrate how keyboard module 122 may automatically generate and display phrases of iconographic symbols, the techniques are described now with reference to the text message exchange shown in user interface 114. As shown in FIG. 1, a user of computing device 110 may exchange electronic communications (e.g., messages) with the friend from within user interface 114. The user may begin the conversation by providing gesture input at locations of PSD 112 at which keys 118A are displayed and a spatial and/or language model of keyboard module 122 may determine, based on the input, that the gesture input corresponds to a selection of keys 118A for entering the phrase “my last exam was today”. The user may provide input at a location of the return key of keys 118A and in response, the messaging application associated with user interface 114 may send an electronic communication to a computing device associate with the friend that includes the text “my last exam was today”. After receiving a reply message from the computing device associated with the friend that includes the text “congrats me too”, the messaging application may present the text of the reply within user interface 114. The user of computing device 110 may provide further input for sending a second message to the friend and in response, the messaging application associated with user interface 114 may send an electronic communication to the computing device associate with the friend that includes the text “it feels so good to finally be done with college”.

After keyboard module 122 receives user input indicating that the user of computing device 110 consents to providing keyboard module 122 with access to personal information about the user (e.g., text of messages sent and received by computing device 110), keyboard module 122 may determine, based at least in part on the text of the electronic communications being sent and received by computing device 110, an implied user-expression that characterizes at least a portion of the text and may further generate a phrase of one or more iconographic symbols that represent the implied user-expression. For example, keyboard module 122 may rely on various models and/or text analysis engines that parse and analyze text being input at graphical keyboard 116B to detect if a user has typed something at graphical keyboard 116B that could be characterized by an expression (e.g., a sentence or phrase) which could also be conveyed in the form of an idiographic symbol phrase. Keyboard module 122 may determine that the user expression “it is time to celebrate graduation” is a user-expression that characterizes the text of the messages shown in user interface 114.

Keyboard module 122 may only analyze text of electronic communications of the user after first receiving explicit permission from the user to do-so. Thus, the user may have complete control over how the keyboard module 122 collects and uses information about the user. For example, prior to analyzing text of a communication associated with the user of computing device 110, keyboard module 122 may cause UI module 120 to present a user interface via UID 112 that requests a user to select a box, click a button, state a voice input, or otherwise provide a specific input to the user interface that is interpreted by keyboard module 122 as unambiguous, affirmative consent for keyboard module to collect and make use of the user's personal information.

Keyboard module 122 may rely on artificial intelligence and machine learning techniques to A) determine with a degree of confidence, a user-expression that characterizes and/or is implied by the text but is not necessarily stated in the text and/or B) to generate a phrase of one or more iconographic symbols that represent a user-expression not necessarily stated in the text. Keyboard module 122 may rely on a machine learned model, including artificial neural networks, recurrent neural networks, long short-term memory (LSTM) models, Hidden Markov Models or any and all other types of machine learned type models that uses learned rules to determine with a degree of certainty whether text being input at graphical keyboard 116B is related to a particular user-expression or iconographic symbol phrase.

For example, in the case of a LSTM model, the LSTM model of keyboard module 122 may initially be trained on chat conversations of multiple other users and multiple other devices to detect, with confidence, what a user is conversing about that might be relevant to an iconographic symbol phrase. The LSTM model may rely on contextual information of computing device 110, text from other users in a conversation with a user of computing device 110, or text on a screen of computing devices of the other users, to determine with greater confidence what a user is typing about.

The LSTM model may learn user-expressions that characterize the text and/or are implied but not necessarily stated in the text. Keyboard module 122 may pick up on learned cultural, local, and multilingual references and context and update its model accordingly. For example, the LSTM model may learn when a user in a particular geographic location may be expressing an emotion (e.g., love, hope, jubilation, fear, anger, etc.) an action (e.g., making a purchase, completing a milestone, etc.), a thought (e.g., a political statement, an observation, etc.), or other expression. For a different geographic location, the LSTM model may have different rules for interpreting when a user is expressing an emotion, an action, a thought, or other similar expression. For example, the LSTM model of keyboard module 122 may pick-up on words such as “exam”, “done”, and “congrats” as indicators that the user and his or her friend are expressing their “excitement” about “graduating college” and determine that when other users of other devices have used similar words in text conversations to express excitement about a similar event, they often used a phrase or terminology such as “time to celebrate” and/or “graduation”. Keyboard module 122 may determine that “it is time to celebrate graduation” is a user-expression that characterizes the text of the messages shown in user interface 114.

Keyboard module 122 may provide text of a conversation, or a portion thereof, as input to an LSTM model, and receive as output, one or more predicted iconographic symbol phrases. For example, the LSTM model may rely on an Objective-C library or other translation model that converts the implied user-expression into an iconographic symbol phrase prediction. In the end, the LSTM model may output one or more iconographic symbol phrase predictions that the multiple other users have used when conversing about a similar user-expression. For example, after determining that “it is time to celebrate graduation” is a user-expression that characterizes the text of the messages shown in user interface 114, keyboard module 122 may determine that the emoji symbol phrase (which includes a clock emoji symbol, a party favor emoji symbol, and a graduation cap emoji symbol) is an iconographic symbol phrase for pictographically expressing the user-expression “it is time to celebrate graduation”.

Keyboard module 122 may output, for display within graphical keyboard 116C, a graphical indication of the phrase of one or more iconographic symbols that the model has predicted from the text. For example, keyboard module 122 may cause search element 118C to flash or change format, change shape, change color, move, or perform some other animation to indicate that the iconographic symbol phrase was generated. In addition, or alternatively, keyboard module 122 may output the iconographic symbol phrase as a suggestion (e.g., at suggestion region 118B), text of the user-expression as a blue hyperlink (e.g., underlined or not underlined) leading to a page of one or more iconographic symbol phrases that keyboard module 122 has generated based on the user-expression, and/or an icon associated with the iconographic symbol phrase (e.g., a generic emoji symbol to indicate the generation of an iconographic symbol phrase).

After automatically presenting an indication of an iconographic symbol phrase within graphical keyboard 116B, a user may select the iconographic symbol phrase and cause keyboard module 122 to input iconographic symbol phrase as text in a message being composed from computing device 110. For instance, a user may provide a tap or swipe gesture at a location of PSD 112 at which suggestion region 118B is displayed and in response to receiving, from UI module 120, an indication of the tap or swipe gesture, keyboard module 122 may insert the iconographic symbol phrase into edit region 116C or forgo inserting the iconographic symbol phrase into edit region 116C and instead, automatically send the iconographic symbol phrase in the body of a new electronic message.

By providing a GUI that includes a graphical keyboard with integrated iconographic symbol phrase prediction, an example computing device may provide a way for a user to quickly obtain iconographic symbol phrase predictions that are relevant to the input that the user has already provided at the graphical keyboard, without having to switch between several different application GUIs, re-type text already input at the graphical keyboard, or come up with a relevant iconographic symbol phrase on his or her own. In other words, unlike other computing devices that require a user to exit out of a chat application GUI and provide subsequent text input (e.g., by pasting or re-typing text previously entered at the chat application) at a different iconographic symbol input GUI to search for iconographic symbols that are related to a topic previously entered at the chat application, the example computing device automatically predicts an iconographic symbol phrase and offers the iconographic symbol phrase for selection without requiring the user to provide any additional input beyond what he or she originally typed when typing the original chat message. In this way, techniques of this disclosure may reduce the amount of time and the number of user inputs required to obtain iconographic symbol phrase predictions that are related to chat conversations, which may simplify the user experience and may reduce power consumption of the computing device.

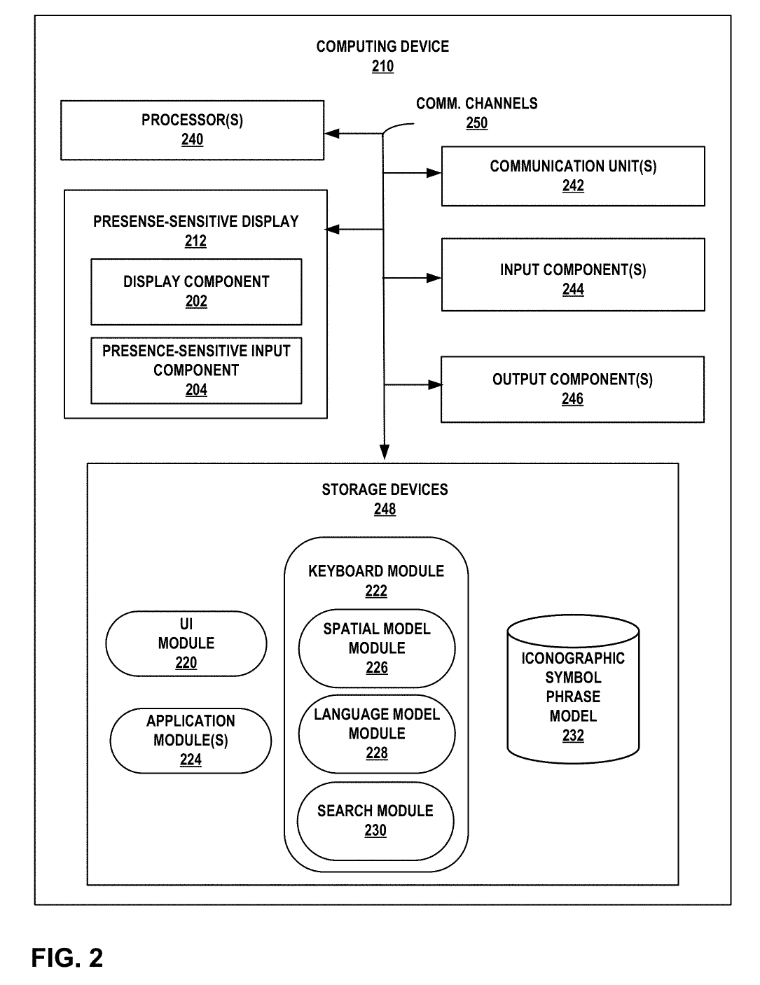

FIG. 2 is a block diagram illustrating computing device 210 as an example computing device that is configured to present a graphical keyboard with integrated iconographic symbol based predictions, in accordance with one or more aspects of the present disclosure. Computing device 210 of FIG. 2 is described below as an example of computing device 110 of FIG. 1. FIG. 2 illustrates only one example of computing device 210, and many other examples of computing device 210 may be used in other instances. Computing device 210 may include a subset of the components included in FIG. 2 or may include additional components not shown in FIG. 2.

As shown in the example of FIG. 2, computing device 210 includes PSD 212, one or more processors 240, one or more communication units 242, one or more input components 244, one or more output components 246, and one or more storage components 248. Presence-sensitive display 212 includes display component 202 and presence-sensitive input component 204. Storage components 248 of computing device 210 include UI module 220, keyboard module 222, and one or more application modules 224. Keyboard module 222 includes spatial model (“SM”) module 226, language model (“LM”) module 228, and search module 230. Storage devices 248 also includes iconographic symbol phrase model 232 (e.g., a LSTM or other machine learned model). Communication channels 250 may interconnect each of the components 212, 240, 242, 244, 246, and 248 for inter-component communications (physically, communicatively, and/or operatively). In some examples, communication channels 250 may include a system bus, a network connection, an inter-process communication data structure, or any other method for communicating data.

One or more communication units 242 of computing device 210 may communicate with external devices via one or more wired and/or wireless networks by transmitting and/or receiving network signals on the one or more networks. Examples of communication units 242 include a network interface card (e.g. such as an Ethernet card), an optical transceiver, a radio frequency transceiver, a GPS receiver, or any other type of device that can send and/or receive information. Other examples of communication units 242 may include short wave radios, cellular data radios, wireless network radios, as well as universal serial bus (USB) controllers.

One or more input components 244 of computing device 210 may receive input. Examples of input are tactile, audio, and video input. Input components 242 of computing device 210, in one example, includes a presence-sensitive input device (e.g., a touch sensitive screen, a PSD), mouse, keyboard, voice responsive system, video camera, microphone or any other type of device for detecting input from a human or machine. In some examples, input components 242 may include one or more sensor components one or more location sensors (GPS components, Wi-Fi components, cellular components), one or more temperature sensors, one or more movement sensors (e.g., accelerometers, gyros), one or more pressure sensors (e.g., barometer), one or more ambient light sensors, and one or more other sensors (e.g., microphone, camera, infrared proximity sensor, hygrometer, and the like). Other sensors may include a heart rate sensor, magnetometer, glucose sensor, hygrometer sensor, olfactory sensor, compass sensor, step counter sensor, to name a few other non-limiting examples.

One or more output components 246 of computing device 110 may generate output. Examples of output are tactile, audio, and video output. Output components 246 of computing device 210, in one example, includes a PSD, sound card, video graphics adapter card, speaker, cathode ray tube (CRT) monitor, liquid crystal display (LCD), or any other type of device for generating output to a human or machine.

PSD 212 of computing device 210 may be similar to PSD 112 of computing device 110 and includes display component 202 and presence-sensitive input component 204. Display component 202 may be a screen at which information is displayed by PSD 212 and presence-sensitive input component 204 may detect an object at and/or near display component 202. As one example range, presence-sensitive input component 204 may detect an object, such as a finger or stylus that is within two inches or less of display component 202. Presence-sensitive input component 204 may determine a location (e.g., an [x, y] coordinate) of display component 202 at which the object was detected. In another example range, presence-sensitive input component 204 may detect an object six inches or less from display component 202 and other ranges are also possible. Presence-sensitive input component 204 may determine the location of display component 202 selected by a user's finger using capacitive, inductive, and/or optical recognition techniques. In some examples, presence-sensitive input component 204 also provides output to a user using tactile, audio, or video stimuli as described with respect to display component 202. In the example of FIG. 2, PSD 212 may present a user interface (such as graphical user interface 114 of FIG. 1).

While illustrated as an internal component of computing device 210, PSD 212 may also represent an external component that shares a data path with computing device 210 for transmitting and/or receiving input and output. For instance, in one example, PSD 212 represents a built-in component of computing device 210 located within and physically connected to the external packaging of computing device 210 (e.g., a screen on a mobile phone). In another example, PSD 212 represents an external component of computing device 210 located outside and physically separated from the packaging or housing of computing device 210 (e.g., a monitor, a projector, etc. that shares a wired and/or wireless data path with computing device 210).

PSD 212 of computing device 210 may detect two-dimensional and/or three-dimensional gestures as input from a user of computing device 210. For instance, a sensor of PSD 212 may detect a user's movement (e.g., moving a hand, an arm, a pen, a stylus, etc.) within a threshold distance of the sensor of PSD 212. PSD 212 may determine a two or three-dimensional vector representation of the movement and correlate the vector representation to a gesture input (e.g., a hand-wave, a pinch, a clap, a pen stroke, etc.) that has multiple dimensions. In other words, PSD 212 can detect a multi-dimension gesture without requiring the user to gesture at or near a screen or surface at which PSD 212 outputs information for display. Instead, PSD 212 can detect a multi-dimensional gesture performed at or near a sensor which may or may not be located near the screen or surface at which PSD 212 outputs information for display.

One or more processors 240 may implement functionality and/or execute instructions associated with computing device 210. Examples of processors 240 include application processors, display controllers, auxiliary processors, one or more sensor hubs, and any other hardware configure to function as a processor, a processing unit, or a processing device. Modules 220, 222, 224, 226, 228, and 230 may be operable by processors 240 to perform various actions, operations, or functions of computing device 210. For example, processors 240 of computing device 210 may retrieve and execute instructions stored by storage components 248 that cause processors 240 to perform the operations modules 220, 222, 224, 226, 228, and 230. The instructions, when executed by processors 240, may cause computing device 210 to store information within storage components 248.

One or more storage components 248 within computing device 210 may store information for processing during operation of computing device 210 (e.g., computing device 210 may store data accessed by modules 220, 222, 224, 226, 228, and model 232 during execution at computing device 210). In some examples, storage component 248 is a temporary memory, meaning that a primary purpose of storage component 248 is not long-term storage. Storage components 248 on computing device 210 may be configured for short-term storage of information as volatile memory and therefore not retain stored contents if powered off. Examples of volatile memories include random access memories (RAM), dynamic random access memories (DRAM), static random access memories (SRAM), and other forms of volatile memories known in the art.

Storage components 248, in some examples, also include one or more computer-readable storage media. Storage components 248 in some examples include one or more non-transitory computer-readable storage mediums. Storage components 248 may be configured to store larger amounts of information than typically stored by volatile memory. Storage components 248 may further be configured for long-term storage of information as non-volatile memory space and retain information after power on/off cycles. Examples of non-volatile memories include magnetic hard discs, optical discs, floppy discs, flash memories, or forms of electrically programmable memories (EPROM) or electrically erasable and programmable (EEPROM) memories. Storage components 248 may store program instructions and/or information (e.g., data) associated with models 232 and 233 and modules 220, 222, 224, 226, 228, and 230. Storage components 248 may include a memory configured to store data or other information associated with model 232 and modules 220, 222, 224, 226, 228, and 230.

UI module 220 may include all functionality of UI module 120 of computing device 110 of FIG. 1 and may perform similar operations as UI module 120 for managing a user interface (e.g., user interface 114) that computing device 210 provides at presence-sensitive display 212 for handling input from a user. For example, UI module 220 of computing device 210 may query keyboard module 222 for a keyboard layout (e.g., an English language QWERTY keyboard, etc.). UI module 220 may transmit a request for a keyboard layout over communication channels 250 to keyboard module 222. Keyboard module 222 may receive the request and reply to UI module 220 with data associated with the keyboard layout. UI module 220 may receive the keyboard layout data over communication channels 250 and use the data to generate a user interface. UI module 220 may transmit a display command and data over communication channels 250 to cause PSD 212 to present the user interface at PSD 212.

In some examples, UI module 220 may receive an indication of one or more user inputs detected at PSD 212 and may output information about the user inputs to keyboard module 222. For example, PSD 212 may detect a user input and send data about the user input to UI module 220. UI module 220 may generate one or more touch events based on the detected input. A touch event may include information that characterizes user input, such as a location component (e.g., [x,y] coordinates) of the user input, a time component (e.g., when the user input was received), a force component (e.g., an amount of pressure applied by the user input), or other data (e.g., speed, acceleration, direction, density, etc.) about the user input.

Based on location information of the touch events generated from the user input, UI module 220 may determine that the detected user input is associated the graphical keyboard. UI module 220 may send an indication of the one or more touch events to keyboard module 222 for further interpretation. Keyboard module 22 may determine, based on the touch events received from UI module 220, that the detected user input represents an initial selection of one or more keys of the graphical keyboard.

Application modules 224 represent all the various individual applications and services executing at and accessible from computing device 210 that may rely on a graphical keyboard having integrated iconographic symbol phrase prediction. A user of computing device 210 may interact with a graphical user interface associated with one or more application modules 224 to cause computing device 210 to perform an operation or perform a function. Numerous examples of application modules 224 may exist and include, a fitness application, a calendar application, a personal assistant or prediction engine, a search application, a map or navigation application, a transportation service application (e.g., a bus or train tracking application), a social media application, a game application, an e-mail application, a chat or messaging application, an Internet browser application, or any and all other applications that may execute at computing device 210.

Keyboard module 222 may include all functionality of keyboard module 122 of computing device 110 of FIG. 1 and may perform similar operations as keyboard module 122 for providing a graphical keyboard having integrated search features. Keyboard module 222 may include various submodules, such as SM module 226, LM module 228, and search module 230, which may perform the functionality of keyboard module 222.

SM module 226 may receive one or more touch events as input, and output a character or sequence of characters that likely represents the one or more touch events, along with a degree of certainty or spatial model score indicative of how likely or with what accuracy the one or more characters define the touch events. In other words, SM module 226 may infer touch events as a selection of one or more keys of a keyboard and may output, based on the selection of the one or more keys, a character or sequence of characters.

When keyboard module 222 operates in text-entry mode, LM module 228 may receive a character or sequence of characters as input, and output one or more candidate characters, words, or phrases that LM module 228 identifies from a lexicon as being potential replacements for a sequence of characters that LM module 228 receives as input for a given language context (e.g., a sentence in a written language). Keyboard module 222 may cause UI module 220 to present one or more of the candidate words at suggestion regions 118B of user interface 114.

The lexicon of computing device 210 may include a list of words within a written language vocabulary (e.g., a dictionary). For instance, the lexicon may include a database of words (e.g., words in a standard dictionary and/or words added to a dictionary by a user or computing device 210). LM module 228 may perform a lookup in the lexicon, of a character string, to identify one or more letters, words, and/or phrases that include parts or all of the characters of the character string. For example, LM module 228 may assign a language model probability or a similarity coefficient (e.g., a Jaccard similarity coefficient, or other similarity coefficient) to one or more candidate words located at a lexicon of computing device 210 that include at least some of the same characters as the inputted character or sequence of characters. The language model probability assigned to each of the one or more candidate words indicates a degree of certainty or a degree of likelihood that the candidate word is typically found positioned subsequent to, prior to, and/or within, a sequence of words (e.g., a sentence) generated from text input detected by presence-sensitive input component 204 prior to and/or subsequent to receiving the current sequence of characters being analyzed by LM module 228. In response to determining the one or more candidate words, LM module 228 may output the one or more candidate words from lexicon data stores 260A that have the highest similarity coefficients.

Search module 230 of keyboard module 222 may perform integrated search functions on behalf of keyboard module 222 including integrated iconographic symbol phrase prediction. That is, when invoked (e.g., manually in response to a user of computing device 210 selecting selectable element 118C of user interface 114 or other icon, or automatically in response to determining an implied user-expression that characterizes at least a portion of text input), keyboard module 222 may operate in search mode where keyboard module 222 enables computing device 210 to perform search functions from within graphical keyboard 118A, such as predicting and displaying search queries and iconographic symbol phrases that a user of computing device 210 may find relevant for a current conversation.

Model 232 represents an “on-device” (e.g., locally stored and executed) model for use by search module 230 to use for determining whether a user has typed something at graphical keyboard 116B as part of a conversation or whether an invoking application module 224 has received text of a communication (e.g., an instant message) of the conversation, that can be characterized by an iconographic symbol phrase. Model 232 may receive as input, text of a conversation, and output in response, one or more iconographic symbol phrases that may characterize or otherwise be related to portions of the text of the conversation. In some examples, model 232 may output a score associated with an iconographic symbol phrase prediction as an indication of a probability that the phrase is related to the conversation.

If the score assigned to a phrase satisfies a threshold, keyboard module 222 may cause UI module 220 to output a graphical indication of the iconographic symbol phrase as a suggested input. Because what a user types at a particular moment may provide a model with a lot of insight into what she is expressing at the exact moment, keyboard module 222 can use the text to provide the best and most relevant iconographic symbol phrases to expand on that self-expression. In this way keyboard module 222 may provide far more delightful and useful iconographic symbol phrases than other systems that simply use word or phrase matching to recommend an exact matching symbol phrase.

Search module 230 may train model 232, based on phrases of iconographic symbols of previous electronic communications. That is, a learning portion of model 232 may be trained offline to produce rules of iconographic symbol phrase embeddings entered by users of other computing devices or entered by a user of computing device 220. A rules prediction portion of model 232 may execute the learned rules on text input to provide iconographic symbol phrase predictions for passed in text input.

Model 232 may execute locally at one or more processors of computing device 210, unlike other traditional search systems that may rely on models or engines executing at a remote computing system (e.g., a server). By relying on on-device models, such as model 232, search module 230 may perform iconographic symbol phrase predictions in what appears to the user as being near real-time to avoid interrupting or falling behind in a text conversation that a user may be having when typing at graphical keyboard 116B. Alternatively, search module 230 may rely on models, like model 232, that execute remotely. That is, search module 230 may access a cloud service for obtaining iconographic symbol phrase predictions by sending text inferred by graphical keyboard 116B and/or other information about computing device 210 to the cloud, and in response, receiving one or more relevant iconographic symbol phrase predictions.

After receiving explicit consent from a user to store and make use of personal information, search module 230 may encrypt or otherwise treat the information being analyzed to remove the actual identity of the user before storing or making use of the personal. For example, the information may be treated by keyboard module so that any personally-identifiable information is removed when stored or sent to a remote computing device for processing.

Search module 230 may automatically download updated versions of model 232 in response to the location of computing device 210 changing, the language being inputted at graphical keyboard 116B changing, or due to changes in participants in the electronic conversation that a user is having with computing device 220. As an example, one version of model 232 for predicting iconographic symbol phrases for one geographic location may not be appropriate or as accurate for predictions of iconographic symbol phrases in a different geographic location (e.g., due to variances in language, customs, culture, etc. between the two locations). Search module 230 may use one model when the user exchanging text in one language (e.g., a local dialect) and use a different model when exchanging text written in a different language (e.g., a dialect of a home location). Search module 230 may use one model when the user exchanging text with one other user (e.g., a coworker or a friend) use a different model when exchanging text with a different user (e.g., a family member).

Search module 230 may automatically download a new local model 232 in response to the location of computing device 210 changing. For example, search model 230 may receive information from one or more of communication units 242 and/or input components 232 (e.g., a GPS receiver) about the current location of computing device 210. Responsive to determining that the current location does not correspond to the location associated with local model 232, search model 230 may query a remote computing system for a local model for the current location. Upon receiving the local model for the current location from the remote computing system, search model 230 replace the previous local model 232 with a copy of the local model for the current location. In other words, in some examples, search module 230, responsive to determining a change in the current location of computing device 210 from a first location to a second location, may obtain, from a remote computing system, a local model of iconographic symbol phrase predictions for the second location, and may replace the previous local model 232 with the local model for the second location. The new version of local model 232 may have been trained on previous electronic communications sent and received by other computing devices while the other computing devices were located at a current location of the computing device whereas the old version (i.e., the version replaced by the new version) may have been trained on previous electronic communications sent and received by other computing devices while the other computing devices were located at the previous location of the computing device.

Search module 230 may parse text being entered at graphical keyboard 116B to predict, using model 232, an iconographic symbol phrase that represents an implied user-expression that characterizes at least a portion of the text. For example, LM module 228 may determine, based on at least a portion of the text keyboard module 222 infers from a selection of graphical keys 118, one or more words from a lexicon of LM module 228. Search model 230 may input the one or more words into model 232.

Model 232 may determine, based on the words, a score assigned to a user-expression identified by model 232 which indicates a probability that the user-expression is relevant to the one or more words. Responsive to determining the score assigned to the user-expression satisfies a threshold, model 232 may identify the user-expression as the implied user-expression. Said differently, model 232 may refrain from recommending a predicted iconographic symbol phrase associated with an implied user-expression unless the score of the user-expression satisfies a threshold. In this way, the user is not inundated with iconographic symbol phrase predictions when such predictions are not likely to be relevant to the conversation.

Model 232 may determine, based on the implied-user expression and from a local model of searchable phrases of iconographic symbols, a score assigned to a phrase of iconographic symbols indicating a probability that the phrase of iconographic symbols is relevant to the implied user expression. In other words, model 232 may input a user-expression inferred from text into one or more rules for determining an iconographic symbol phrase. The rules may output one or more iconographic symbol phrases, each having its own score indicating how close a match the phrase is to the user-expression. Responsive to determining the score assigned to the phrase of iconographic symbols satisfies a threshold, model 232 may identify that phrase of iconographic symbols as the phrase of one or more iconographic symbols to be recommended to the user.

Search module 230 may obtain, from model 232, an indication of the iconographic symbol phrase and its respective score. Search module 230 may compare the score to a threshold. Responsive to determining the score assigned to an iconographic symbol phrase satisfies the threshold, search module 230 may identify the phrase as being suitable for recommending to the user.

In some examples, search model 230 (e.g., relying on model 232) may further rely on a current context of computing device 210 to predict an iconographic symbol phrase. As used herein, a current context specifies the characteristics of the physical and/or virtual environment of a computing device, such as computing device 210, and a user of the computing device, at a particular time. In addition, the term “contextual information” is used to describe any information that can be used by a computing device to define the virtual and/or physical environmental characteristics that the computing device, and the user of the computing device, may experience at a particular time.

Examples of contextual information are numerous and may include: sensor information obtained by sensors (e.g., position sensors, accelerometers, gyros, barometers, ambient light sensors, proximity sensors, microphones, and any other sensor) of computing device 210, communication information (e.g., text based communications, audible communications, video communications, etc.) sent and received by communication modules of computing device 210 (e.g., including text from other users in a conversation with a user of computing device 210 or text on a screen of computing devices of the other users), and application usage information associated with applications executing at computing device 210 (e.g., application data associated with applications, Internet search histories, text communications, voice and video communications, calendar information, social media posts and related information, etc.). Further examples of contextual information include signals and information obtained from transmitting devices that are external to computing device 210.

Model 232 may rely on contextual information which includes information associated with an electronic conversation that includes the electronic communication that a user may be composing as the user provides input at graphical keyboard 116B, as well as one or more other electronic communications that have been sent or received by computing device 220. For example, model 232 may modify, based on contextual information (e.g., text or other information associated with prior messages sent by computing device 220 and text or other information associated with prior messages received by computing device 220) and from machine learned model 233, a score assigned to an implied user-expression and/or an iconographic symbol phrase. After modifying or refining the score and responsive to determining the score satisfies a threshold, model 232 may identify the user-expression and/or phrases as being relevant to current text input and/or the current context.

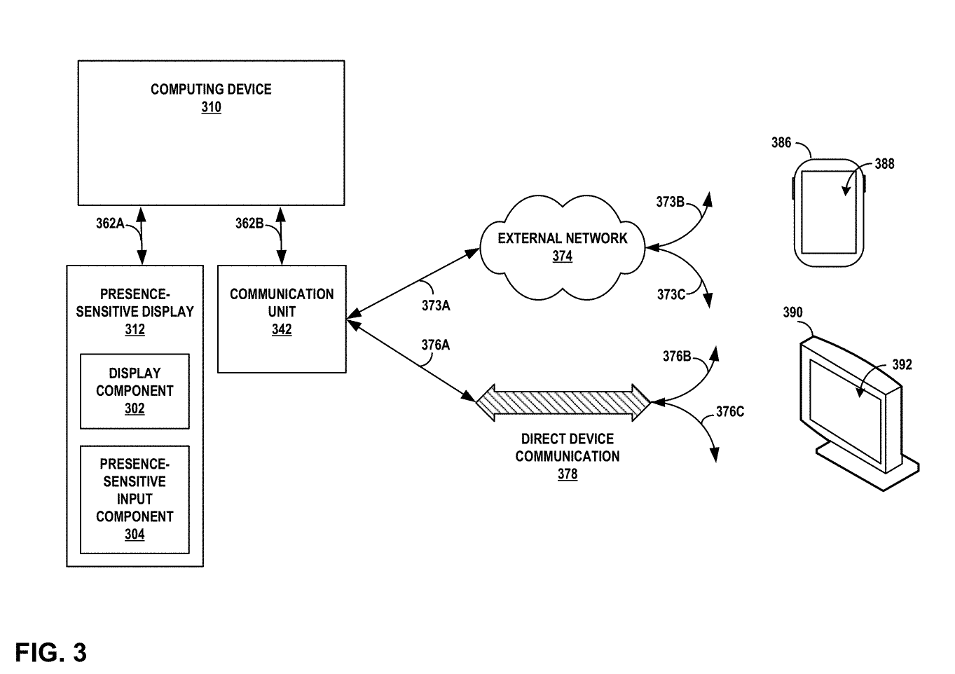

FIG. 3 is a block diagram illustrating an example computing device that outputs graphical content for display at a remote device, in accordance with one or more techniques of the present disclosure. Graphical content, generally, may include any visual information that may be output for display, such as text, images, a group of moving images, to name only a few examples. The example shown in FIG. 3 includes a computing device 310, a PSD 312, communication unit 342, mobile device 386, and visual display component 390. In some examples, PSD 312 may be a presence-sensitive display as described in FIGS. 1-2. Although shown for purposes of example in FIGS. 1 and 2 as a stand-alone computing device 110, a computing device such as computing device 310 may, generally, be any component or system that includes a processor or other suitable computing environment for executing software instructions and, for example, need not include a presence-sensitive display.

As shown in the example of FIG. 3, computing device 310 may be a processor that includes functionality as described with respect to processors 240 in FIG. 2. In such examples, computing device 310 may be operatively coupled to PSD 312 by a communication channel 362A, which may be a system bus or other suitable connection. Computing device 310 may also be operatively coupled to communication unit 342, further described below, by a communication channel 362B, which may also be a system bus or other suitable connection. Although shown separately as an example in FIG. 3, computing device 310 may be operatively coupled to PSD 312 and communication unit 342 by any number of one or more communication channels.

In other examples, such as illustrated previously by computing device 110 in FIGS. 1-2, a computing device may refer to a portable or mobile device such as mobile phones (including smart phones), laptop computers, etc. In some examples, a computing device may be a desktop computer, tablet computer, smart television platform, camera, personal digital assistant (PDA), server, or mainframes.

PSD 312 may include display component 302 and presence-sensitive input component 304. Display component 302 may, for example, receive data from computing device 310 and display the graphical content. In some examples, presence-sensitive input component 304 may determine one or more user inputs (e.g., continuous gestures, multi-touch gestures, single-touch gestures) at PSD 312 using capacitive, inductive, and/or optical recognition techniques and send indications of such user input to computing device 310 using communication channel 362A. In some examples, presence-sensitive input component 304 may be physically positioned on top of display component 302 such that, when a user positions an input unit over a graphical element displayed by display component 302, the location at which presence-sensitive input component 304 corresponds to the location of display component 302 at which the graphical element is displayed.

As shown in FIG. 3, computing device 310 may also include and/or be operatively coupled with communication unit 342. Communication unit 342 may include functionality of communication unit 242 as described in FIG. 2. Examples of communication unit 342 may include a network interface card, an Ethernet card, an optical transceiver, a radio frequency transceiver, or any other type of device that can send and receive information. Other examples of such communication units may include Bluetooth, 3G, and Wi-Fi radios, Universal Serial Bus (USB) interfaces, etc. Computing device 310 may also include and/or be operatively coupled with one or more other devices (e.g., input devices, output components, memory, storage devices) that are not shown in FIG. 3 for purposes of brevity and illustration.

FIG. 3 also illustrates mobile device 386 and visual display component 390. Mobile device 386 and visual display component 390 may each include computing and connectivity capabilities. Examples of mobile device 386 may include e-reader devices, convertible notebook devices, hybrid slate devices, etc. Examples of visual display component 390 may include other devices such as televisions, computer monitors, etc. In some examples, visual display component 390 may be a vehicle cockpit display or navigation display (e.g., in an automobile, aircraft, or some other vehicle). In some examples, visual display component 390 may be a home automation display or some other type of display that is separate from computing device 310.

As shown in FIG. 3, mobile device 386 may include a presence-sensitive display 388. Visual display component 390 may include a presence-sensitive display 392. Presence-sensitive displays 388, 392 may include a subset of functionality or all of the functionality of presence-sensitive display 112, 212, and/or 312 as described in this disclosure. In some examples, presence-sensitive displays 388, 392 may include additional functionality. In any case, presence-sensitive display 392, for example, may receive data from computing device 310 and display the graphical content. In some examples, presence-sensitive display 392 may determine one or more user inputs (e.g., continuous gestures, multi-touch gestures, single-touch gestures) at projector screen using capacitive, inductive, and/or optical recognition techniques and send indications of such user input using one or more communication units to computing device 310.

As described above, in some examples, computing device 310 may output graphical content for display at PSD 312 that is coupled to computing device 310 by a system bus or other suitable communication channel. Computing device 310 may also output graphical content for display at one or more remote devices, such mobile device 386 and visual display component 390. For instance, computing device 310 may execute one or more instructions to generate and/or modify graphical content in accordance with techniques of the present disclosure. Computing device 310 may output the data that includes the graphical content to a communication unit of computing device 310, such as communication unit 342. Communication unit 342 may send the data to one or more of the remote devices, such as mobile device 386 and/or visual display component 390. In this way, computing device 310 may output the graphical content for display at one or more of the remote devices. In some examples, one or more of the remote devices may output the graphical content at a presence-sensitive display that is included in and/or operatively coupled to the respective remote devices.

In some examples, computing device 310 may not output graphical content at PSD 312 that is operatively coupled to computing device 310. In other examples, computing device 310 may output graphical content for display at both a PSD 312 that is coupled to computing device 310 by communication channel 362A, and at one or more remote devices. In such examples, the graphical content may be displayed substantially contemporaneously at each respective device. In some examples, graphical content generated by computing device 310 and output for display at PSD 312 may be different than graphical content display output for display at one or more remote devices.

Computing device 310 may send and receive data using any suitable communication techniques. For example, computing device 310 may be operatively coupled to external network 374 using network link 373A. Each of the remote devices illustrated in FIG. 3 may be operatively coupled to network external network 374 by one of respective network links 373B, or 373C. External network 374 may include network hubs, network switches, network routers, etc., that are operatively inter-coupled thereby providing for the exchange of information between computing device 310 and the remote devices illustrated in FIG. 3. In some examples, network links 373A-373C may be Ethernet, ATM or other network connections. Such connections may be wireless and/or wired connections.

In some examples, computing device 310 may be operatively coupled to one or more of the remote devices included in FIG. 3 using direct device communication 378. Direct device communication 378 may include communications through which computing device 310 sends and receives data directly with a remote device, using wired or wireless communication. That is, in some examples of direct device communication 378, data sent by computing device 310 may not be forwarded by one or more additional devices before being received at the remote device, and vice-versa. Examples of direct device communication 378 may include Bluetooth, Near-Field Communication, Universal Serial Bus, Wi-Fi, infrared, etc. One or more of the remote devices illustrated in FIG. 3 may be operatively coupled with computing device 310 by communication links 376A-376C. In some examples, communication links 376A-376C may be connections using Bluetooth, Near-Field Communication, Universal Serial Bus, infrared, etc. Such connections may be wireless and/or wired connections.

In accordance with techniques of the disclosure, computing device 310 may be operatively coupled to visual display component 390 using external network 374. Computing device 310 may output a graphical keyboard for display at PSD 392. For instance, computing device 310 may send data that includes a representation of the graphical keyboard to communication unit 342. Communication unit 342 may send the data that includes the representation of the graphical keyboard to visual display component 390 using external network 374. Visual display component 390, in response to receiving the data using external network 374, may cause PSD 392 to output the graphical keyboard. In response to receiving a user input at PSD 392 to select one or more keys of the keyboard, visual display device 130 may send an indication of the user input to computing device 310 using external network 374. Communication unit 342 of may receive the indication of the user input, and send the indication to computing device 310.

Computing device 310 may determine, based on the user input, a selection of one or more keys. Computing device 310 may determine, based on the selection of one or more keys, one or more words. Computing device 310 may identify, based at least in part on the one or more words, an implied user-expression that characterizes at least a portion of the one or more words and may generate, based on the implied user-expression, a phrase of one or more iconographic symbols that represents the implied user-expression. Computing device 310 may output, for display within the graphical keyboard, a graphical indication to indicate that the computing device predicted the phrase. Communication unit 342 may receive the representation of the updated graphical user interface and may send the send the representation to visual display component 390, such that visual display component 390 may cause PSD 392 to output the updated graphical keyboard, including the graphical indication to indicate that the computing device generated the phrase of one or more iconographic symbols.

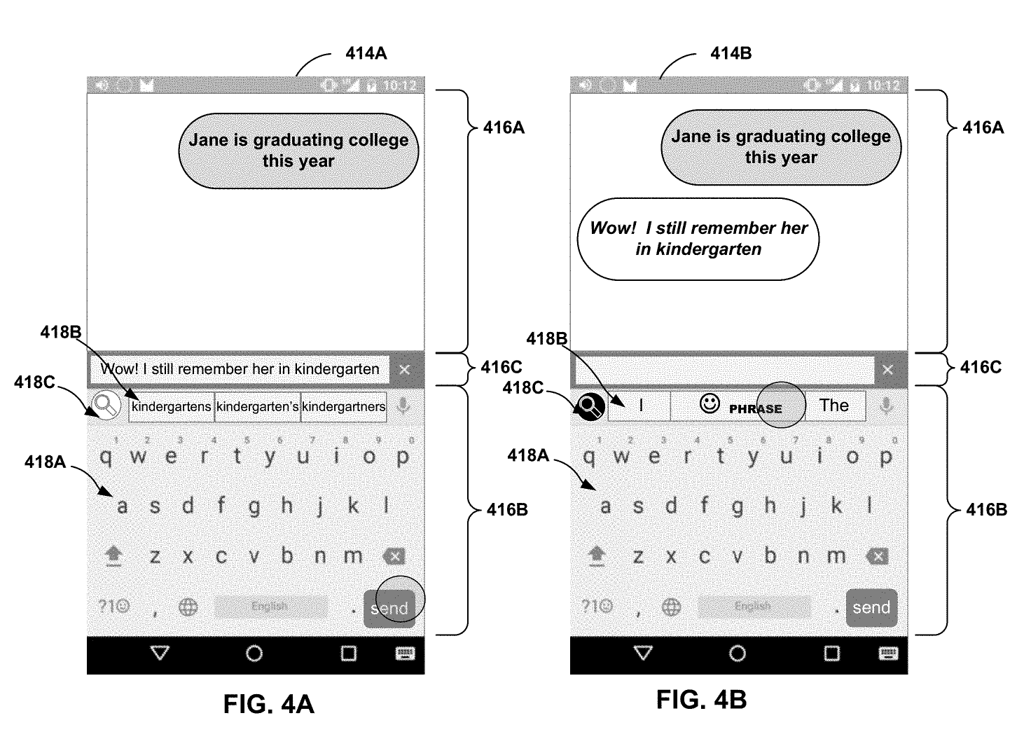

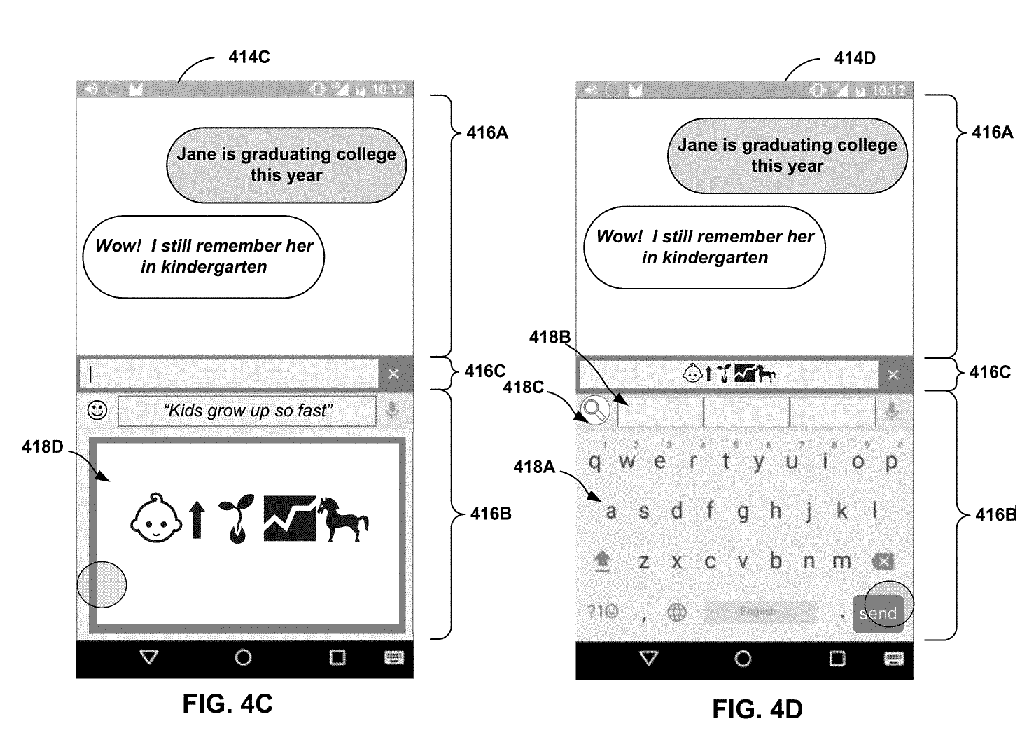

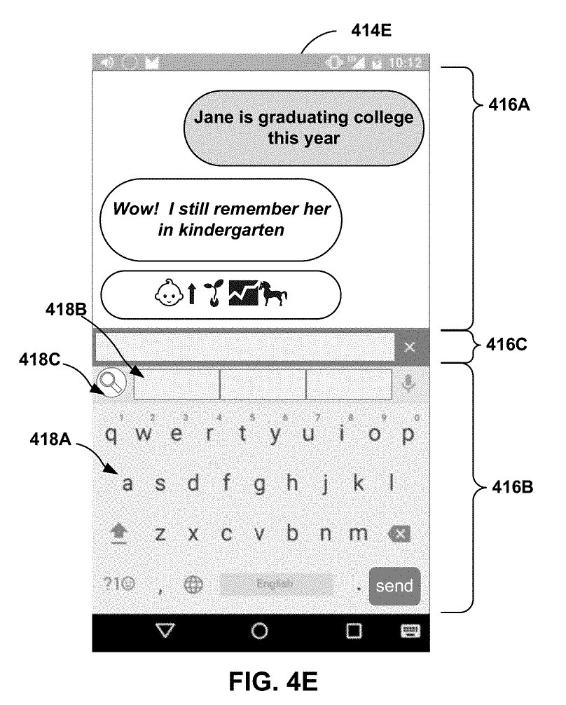

FIGS. 4A-4E are conceptual diagrams illustrating example graphical user interfaces of an example computing device that is configured to present a graphical keyboard with integrated iconographic symbol based predictions, in accordance with one or more aspects of the present disclosure. FIGS. 4A-4E illustrate, respectively, example graphical user interfaces 414A-414E (collectively, user interfaces 414). However, many other examples of graphical user interfaces may be used in other instances. Each of graphical user interfaces 414 may correspond to a graphical user interface displayed by computing devices 110 or 210 of FIGS. 1 and 2 respectively. FIGS. 4A-4E are described below in the context of computing device 110.

Graphical user interfaces 414 include output region 416A, edit region 416C, and graphical keyboard 416B. Graphical keyboard 416B includes suggestion region 418B, a plurality of keys 418A, and search element 418C.

As shown in FIG. 4A, computing device 110 may receive an electronic communication (e.g., a text message) from a device associated with a family member. Computing device 110 may output the content of the electronic communication for display within output region 416A. The content of the message may include the phrase “Jane is graduating from college this year”.

The user of computing device 110 may interact with graphical keyboard 416B to compose a reply to the message. For example, the user may tap or gesture at one or more keys 418A to type the reply as “Wow! I still remember her in kindergarten”. Keyboard module 122 of computing device 110 may receive an indication of the taps or gestures at keys 418A and determine, based on the user input, text that computing device 110 formats and displays within edit region 416C. For example, as the user types “kindergarten” computing device 110 may cause edit region 416C to display “kindergarten”. In addition, as the user types at graphical keys 418A, keyboard module 122 of computing device 110 may predict one or more candidate words based on the user input and display one or more of the candidate words within suggestion region 418B (e.g., “kindergartens”, “kindergarten's”, and “kindergarteners”). In response to detecting a selection of the “send key” of graphical keys 418A, computing device 110 may compose and send an electronic message that includes the text “Wow! I still remember her in kindergarten” to the computing device associate with the family member. As shown in FIG. 4A, computing device 110 may output the content of the electronic message for display within output region 416A.

After the user finishes typing text associated with an electronic communication, keyboard module 122 of computing device 110 may automatically infer that the user is finished typing and in response, determine an implied user-expression that characterizes at least a portion of the text written in the message from the family member and/or the reply message composed with graphical keyboard 416B. Keyboard module 122 of computing device 110 may determine the implied user-expression in response to determining an end of the text associated with an electronic communication. For example, keyboard module 122 may determine the end of the text in one or more several ways. Keyboard module 122 may determine an implied user-expression in response to determining that a final character in the text is a punctuation character (e.g., ‘?’, ‘.’, !′, or some other punctuation character). In other words, keyboard module 122 may determine an implied user-expression in response to determining that a last key of the selection of one or more keys of graphical keyboard 416B corresponds to a punctuation key associated with a punctuation character. Keyboard module 122 of computing device 110 may determine an implied user-expression in response to determining that a final key selected by a user is the “send key” or “return key” that when selected, triggers the chat application of computing device 110 to send a message. In other words, keyboard module 122 may determine an implied user-expression in response to determining that the last key of the selection of one or more keys of graphical keyboard 416B corresponds to a send key of graphical keyboard 416B to cause computing device 110 to send the electronic communication. Keyboard module 122 of computing device 110 may determine an implied user-expression in response to determining that a pause in user inputs (e.g., one or more seconds of time) associated with graphical keyboard 416B has occurred since the last key was selected or that a quantity of words (e.g., any quantity greater than one) associated with the text exceeds a word threshold.

In response to determining an implied user-expression that characterizes at least a portion of the text of the electronic conversation, keyboard module 122 may enter search mode and predict a phrase of iconographic symbols that may be relevant to the text. Keyboard module 122 may analyze the “Jane is graduating college this year” and “Wow! I still remember her in kindergarten” and infer that the user of computing device 110 is having a conversation about children growing up. Keyboard module 122 may automatically associate a phrase of one or more iconographic symbols that other users of other computing devices have used when having conversations about kids or children growing up. For example, keyboard module 122 may determine that the emoji symbol phrase shown as phrase result in search region 418D of user interface 414C in FIG. 4C, and might be interpreted as standing for “kids grow up so fast”, has been used by users of other computing devices when having a conversation about children growing up.

In some examples, computing device 110 may modify a visual format of a search key from the plurality of keys to indicate that the computing device generated the iconographic symbol phrase. For example, as shown in FIG. 4B, search element 418C has changed from being displayed in a first visual format in which search element 418C has a first color pallet, to a second visual format in which search element 418C is displayed having a second color pallet. In other examples, computing device 110 may cause search element 418C to flash, move, change size, morph from a first icon to a second, different icon, or be altered in some other way in which to alert a user that computing device 110 predicted an iconographic symbol phrase based on text input at graphical keyboard 416B.

In some examples, computing device 110 may indicate that the computing device predicted an iconographic symbol phrase by outputting text or a graphical indication of the predicted phrase. For example, computing device 110 may output the text or a graphical indication of the predicted phrase as a suggestion within suggestion region 418B of graphical keyboard 416B so that the iconographic symbol phrase, when displayed within suggestion region 418B, is displayed in and amongst, linguistic, candidate words or phrases (e.g., non-search related suggestions). In other examples, computing device 110 may indicate that the computing device generated text or a graphical indication of the predicted phrase by outputting a graphical element (e.g., an icon) representative or generic to iconographic symbol phrases with or without a text descriptor. For example, as shown in FIG. 4B, computing device 110 may output the smiley face emoji symbol [symbol] with the text “phrase” to indicate that keyboard module 122 generated a predicted phrase.

In some examples, computing device 110 may display a graphical indication of a predicted iconographic symbol phrase within a separate search region of the graphical keyboard. The search region may be different than suggestion region 418B of graphical keyboard 416B in which suggested words for text entry are displayed. For example, the search region may be positioned between graphical keys 418A and suggestion region 418C or the search region may be positioned between edit region 416C or output region 416A and suggestion region 418B. In some examples, computing device 110 may even replace suggestion region 418B with the search region.

FIG. 4C shows an example of an iconographic symbol search region that computing device 110 may display in response to receiving an indication of a selection of the graphical indication of the phrase of iconographic symbols. In other words, upon detecting a selection of the phrase suggestion from suggestion region 418B of FIG. 4B, computing device 110 may display user interface 414C in which the actual iconographic symbol phrase is shown in a separate search region 418D that replaces at least a portion of graphical keyboard 416B.

A user may provide input at search region 418D to select an iconographic symbol phrase for entry as part of an electronic communication. In some instances, keyboard module 122 may display the predicted implied user-expression and display the implied user-expression as a suggested search query from which the user may search for other iconographic symbol phrases, stickers, images, videos, or other content related to the implied user-expression. In addition, the user may provide additional input to refine the implied user-expression to obtain different iconographic symbol phrases or different search results than those automatically found by computing device 110.

After displaying a graphical indication of a phrase of one or more iconographic symbols, computing device 110 may receive an indication of a selection of the graphical indication of the iconographic symbol phrase, and responsive to receiving the indication of the selection of the graphical indication, computing device 110 may output the phrase as part of the electronic communication. For example, as shown in FIG. 4B, keyboard module 122 may receive an indication of user input detected at a location at which the predicted phrase is displayed within suggestion region 418B. Responsive to receiving the indication of the user input, computing device 110 may output, for display, within edit region 416C, the predicted phrase.

A shown in FIG. 4D, a user may provide additional input at the “send key” to cause computing device 110 to send a message with the contents of edit region 416C. For example, as shown in FIG. 4E, computing device 110 may output a message with the predicted phrase to the family member device and display the contents of the message within output region 416A of user interface 414E.

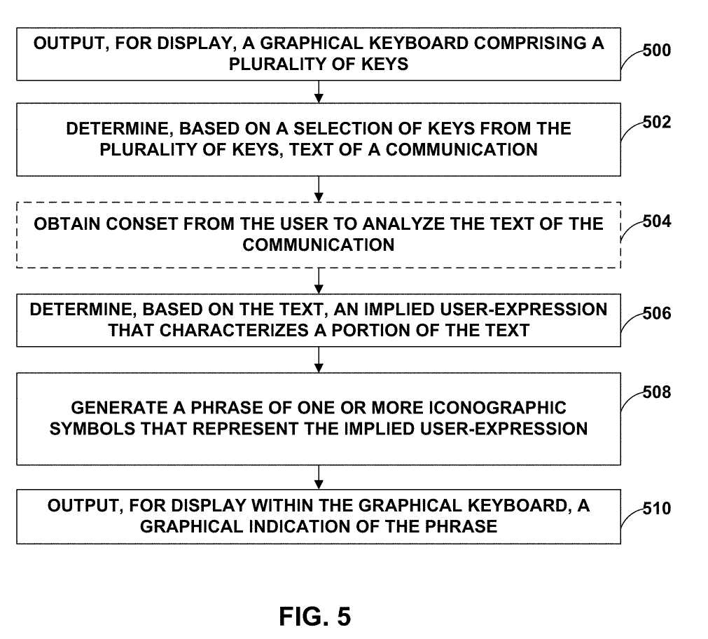

FIG. 5 is a flowchart illustrating example operations of a computing device that is configured to present a graphical keyboard with integrated iconographic symbol based predictions, in accordance with one or more aspects of the present disclosure. The operations of FIG. 5 may be performed by one or more processors of a computing device, such as computing devices 110 of FIG. 1 or computing device 210 of FIG. 2. For purposes of illustration only, FIG. 5 is described below within the context of computing device 110 of FIG. 1.

In operation, computing device 110 may output a graphical keyboard for display (500). For example, a chat application executing at computing device 110 may invoke keyboard module 122 (e.g., a standalone application or function of computing device 110 that is separate from the chat application) to present graphical keyboard 116B at PSD 112.

Computing device 110 may output, for display, a graphical keyboard comprising a plurality of keys (500). For example, keyboard module 122 may cause UI module 12 to display, at PSD 112, user interface 114 including graphical keyboard 116B.

Computing device 110 may determine, based at least in part on an indication of a selection of one or more keys from the plurality of keys, text of an electronic communication (502). For example, as a user of computing device 110 types at graphical keyboard 116B, keyboard module 122 may receive data from PSD 112 and UI module 120 that indicates which keys 118A of keyboard 116B are being selected. Keyboard module 122 may determine that the user has typed the words “my last exam was today” and “it feels good to finally be done with college”.

Computing device 110 may obtain consent from the user to analyze the text of the communication (504). For example, keyboard module 122 may only analyze text of electronic communications of the user after first receiving explicit permission from the user to do-so. Thus, the user may have complete control over how the keyboard module 122 collects and uses information about the user. For example, prior to analyzing text of a communication associated with the user of computing device 110, keyboard module 122 may cause UI module 120 to present a user interface via UID 112 that requests a user to select a box, click a button, state a voice input, or otherwise provide a specific input to the user interface that is interpreted by keyboard module 122 as unambiguous, affirmative consent for keyboard module to collect and make use of the user's personal information.

Computing device 110 may determine, based at least in part on the text, an implied user-expression that characterizes at least a portion of the text (506). For example, keyboard module 122 may rely on a model (such as model 232 of computing device 220) that parses and analyze text being input at graphical keyboard 116B to detect if a user has typed something at graphical keyboard 116B that could be characterized by a sentence or phrase which could also be conveyed in the form of an idiographic symbol phrase. Keyboard module 122 may determine that the user expression “it is time to celebrate graduation” is a user-expression that users of other computing devices have used to characterize similar conversations.

Computing device 110 may generate a phrase of one or more iconographic symbols that represent the implied user-expression (508). For example, keyboard module 122 perform keyword replacement or text phrase replacement of the words or text in an inferred user-expression to automatically generate an iconographic symbol phrase of one or more symbols that represents the user-expression. In some instances, the model relied on keyboard module 122 may determine an iconographic symbol phrase that is often used when users of other computing devices are having a conversation that can be characterized by the determined user-expression.

Computing device 110 may output, for display within the graphical keyboard, a graphical indication of the phrase (510). For example, Keyboard module 122 may output a graphical indication of the phrase by appending or replacing the portion of the text with the phrase that is characterized by the user-expression, with the phrase. Keyboard module 122 may output the iconographic symbol phrase as a suggestion (e.g., at suggestion region 118B), text of the user-expression as a blue hyperlink (e.g., underlined or not underlined) leading to a page of one or more iconographic symbol phrases that keyboard module 122 has generated based on the user-expression, and/or an icon associated with the iconographic symbol phrase (e.g., a generic emoji symbol to indicate the generation of an iconographic symbol phrase).

The following numbered clauses may illustrate one or more aspects of the disclosure:

Clause 1. A method comprising: outputting, by a keyboard application executing at a computing device, for display, a graphical keyboard comprising a plurality of keys; determining, by the keyboard application, based at least in part on an indication of a selection of one or more keys from the plurality of keys, text of an electronic communication; determining, by the keyboard application, based at least in part on the text, an implied user-expression that characterizes at least a portion of the text; generating, by the keyboard application, a phrase of one or more iconographic symbols that represent the implied user-expression; and outputting, by the keyboard application, for display within the graphical keyboard, a graphical indication of the phrase.

Clause 2. The method of clause 1, wherein the implied user-expression is determined in response to determining an end of the text of the electronic communication.

Clause 3. The method of clause 2, further comprising: determining, by the keyboard application, the end of the text of the electronic communication in response to determining: that a last key of the selection of one or more keys corresponds to a punctuation key associated with a punctuation character; that the last key of the selection of one or more keys corresponds to a send key of the graphical keyboard to send the electronic communication; that a pause in user inputs has occurred since the last key was selected; or that a quantity of words associated with the text exceeds a word threshold.

Clause 4. The method of any one of clauses 1-3, further comprising: responsive to receiving an indication of a selection of the graphical indication of the phrase of one or more iconographic symbols, outputting, by the keyboard application, as part of the electronic communication, the phrase of one or more iconographic symbols.

Clause 5. The method of clause 4, wherein outputting the phrase of one or more iconographic symbols as part of the electronic communication comprises appending or replacing the portion of the text with the phrase.

Clause 6. The method of any one of clauses 1-5, wherein outputting the graphical indication of the phrase comprises outputting the graphical indication of the phrase of one or more iconographic symbols as a suggestion within a suggestion region of the graphical keyboard.

Clause 7. The method of any one of clauses 1-6, wherein the graphical indication of the phrase of one or more iconographic symbols comprises a graphical element comprising at least one of text or iconography to indicate that the computing device generated the phrase of one or more iconographic symbols.

Clause 8. The method of clause 7, wherein the phrase of one or more iconographic symbols is a particular phrase from a plurality of iconographic symbol phrases that each represent the implied user-expression, and the graphical indication of the phrase of one or more iconographic symbols further comprises a selectable element or link to additional phrases from the plurality of iconographic symbol phrases.

Clause 9. The method of any one of clauses 1-8, wherein determining the implied user-expression comprises: determining, by the keyboard application, based on at least a portion of the text, one or more words; determining, by the keyboard application, based on the one or more words and from a local model of searchable user-expressions, a score assigned to a particular user-expression indicating a probability that the particular user-expression is relevant to the one or more words; and responsive to determining the score assigned to the particular user-expression satisfies a threshold, identifying, by the keyboard application, the particular user-expression as the implied user-expression.

Clause 10. The method of any one of clauses 1-9, wherein generating the phrase of one or more iconographic symbols comprises: determining, by the keyboard application, based on the implied-user expression and from a local model of searchable phrases of iconographic symbols, a score assigned to a particular phrase of iconographic symbols indicating a probability that the particular phrase of iconographic symbols is relevant to the implied user expression; responsive to determining the score assigned to the particular phrase of iconographic symbols satisfies a threshold, identifying, by the keyboard application, the particular phrase of iconographic symbols as the phrase of one or more iconographic symbols.

Clause 11. The method of clause 10, wherein the local model is associated with a current location of the computing device.

Clause 12. The method of any one of clauses 10 or 11, further comprising: training, by the keyboard application, based on iconographic symbol phrases of previous electronic communications, the local model of searchable phrases of iconographic symbols.

Clause 13. The method of clause 12, wherein the previous electronic communications were sent or received by other computing devices while the other computing devices were located at a current location of the computing device.

Clause 14. The method of any one of clause 10-13, wherein the local model is a first local model, the method further comprising: responsive to determining a change in the current location of the computing device from a first location to a second location: obtaining, by the keyboard application, from a remote computing system, a second model of searchable phrases of iconographic symbols, the second model being associated with the second location; and replacing, by the keyboard application, the first local model with the second model.

Clause 15. A computing device comprising: a presence-sensitive display component; at least one processor; and a memory that stores instructions associated with a keyboard application that, when executed, cause the at least one processor to: output, for display at the presence-sensitive display component, a graphical keyboard comprising a plurality of keys; determine, based at least in part on an indication of a selection of one or more keys from the plurality of keys, text of an electronic communication; determine, based at least in part on the text, an implied user-expression that characterizes at least a portion of the text; generate, a phrase of one or more iconographic symbols that represent the implied user-expression; and output, for display within the graphical keyboard, a graphical indication of the phrase.

Clause 16. The computing device of clause 15, wherein the instructions, when executed, cause the at least one processor to determine the implied user-expression in response to determining an end of the text of the electronic communication.

Clause 17. The computing device of any one of clause 15-16, wherein the keyboard application executes as a keyboard extension of a different application.

Clause 18. The computing device of any one of clause 15-17, wherein the instructions, when executed, further cause the at least one processor to: determine, based on the implied-user expression and from a local model of searchable phrases of iconographic symbols, a score assigned to a particular phrase of iconographic symbols indicating a probability that the particular phrase of iconographic symbols is relevant to the implied user expression; responsive to determining the score assigned to the particular phrase of iconographic symbols satisfies a threshold, identify the particular phrase of iconographic symbols as the phrase of one or more iconographic symbols.

Clause 19. A computer-readable storage medium comprising instructions that when executed cause at least one processor of a computing device to: output, for display, a graphical keyboard comprising a plurality of keys; determine, based at least in part on an indication of a selection of one or more keys from the plurality of keys, text of an electronic communication; determine, based at least in part on the text, an implied user-expression that characterizes at least a portion of the text; generate, a phrase of one or more iconographic symbols that represent the implied user-expression; and output, for display within the graphical keyboard, a graphical indication of the phrase.

Clause 20. The computer-readable storage medium of clause 19, wherein the instructions, when executed, further cause the at least one processor to responsive to receiving an indication of a selection of the graphical indication of the phrase, output, as part of the electronic communication, the phrase of one or more iconographic symbols.

Clause 21. A system comprising means for performing any of the methods of clauses 1-14.

Clause 22. A computing device comprising means for performing any of the methods of clauses 1-14.

Clause 22. A computer-readable storage medium comprising instructions that, when executed by at least one processor of a computing device, cause the at least one processor to perform any of the methods of clauses 1-14.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used may refer to any of the foregoing structure or any other structure suitable for implementation of the techniques described. In addition, in some aspects, the functionality described may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

Various examples have been described. These and other examples are within the scope of the following claims.

What is claimed is:

1. A method comprising:
outputting, by a keyboard application executing at a computing device, for display, a graphical keyboard comprising a plurality of keys;
determining, by the keyboard application, based at least in part on an indication of a selection of one or more keys from the plurality of keys, text of an electronic communication;
determining, by the keyboard application, based at least in part on the text, an implied user-expression that characterizes at least a portion of the text;
generating, by the keyboard application, a phrase of one or more iconographic symbols that represent the implied user-expression; and
outputting, by the keyboard application, for display within the graphical keyboard, a graphical indication of the phrase.

2. The method of claim 1, wherein the implied user-expression is determined in response to determining an end of the text of the electronic communication.

3. The method of claim 2, further comprising:
determining, by the keyboard application, the end of the text of the electronic communication in response to determining:
that a last key of the selection of one or more keys corresponds to a punctuation key associated with a punctuation character;
that the last key of the selection of one or more keys corresponds to a send key of the graphical keyboard to send the electronic communication;
that a pause in user inputs has occurred since the last key was selected; or
that a quantity of words associated with the text exceeds a word threshold.

4. The method of claim 1, further comprising:
responsive to receiving an indication of a selection of the graphical indication of the phrase of one or more iconographic symbols, outputting, by the keyboard application, as part of the electronic communication, the phrase of one or more iconographic symbols.

5. The method of claim 4, wherein outputting the phrase of one or more iconographic symbols as part of the electronic communication comprises appending or replacing the portion of the text with the phrase.

6. The method of claim 1, wherein outputting the graphical indication of the phrase of one or more iconographic symbols comprises outputting the graphical indication of the phrase of one or more iconographic symbols as a suggestion within a suggestion region of the graphical keyboard.

7. The method of claim 1, wherein the graphical indication of the phrase of one or more iconographic symbols comprises a graphical element comprising at least one of text or iconography to indicate that the computing device generated the phrase of one or more iconographic symbols.

8. The method of claim 7, wherein the phrase of one or more iconographic symbols is a particular phrase from a plurality of iconographic symbol phrases that each represent the implied user-expression, and the graphical indication of the phrase of one or more iconographic symbols further comprises a selectable element or link to additional phrases from the plurality of iconographic symbol phrases.

9. The method of claim 1, wherein determining the implied user-expression comprises:
determining, by the keyboard application, based on at least a portion of the text, one or more words;
determining, by the keyboard application, based on the one or more words and from a local model of searchable user-expressions, a score assigned to a particular user-expression indicating a probability that the particular user-expression is relevant to the one or more words; and
responsive to determining the score assigned to the particular user-expression satisfies a threshold, identifying, by the keyboard application, the particular user-expression as the implied user-expression.

10. The method of claim 1, wherein generating the phrase of one or more iconographic symbols comprises:
determining, by the keyboard application, based on the implied-user expression and from a local model of searchable phrases of iconographic symbols, a score assigned to a particular phrase of iconographic symbols indicating a probability that the particular phrase of iconographic symbols is relevant to the implied user expression; and
responsive to determining the score assigned to the particular phrase of iconographic symbols satisfies a threshold, identifying, by the keyboard application, the particular phrase of iconographic symbols as the phrase of one or more iconographic symbols.

11. The method of claim 10, wherein the local model is associated with a current location of the computing device.

12. The method of claim 10, further comprising:
training, by the keyboard application, based on iconographic symbol phrases of previous electronic communications, the local model of searchable phrases of iconographic symbols.

13. The method of claim 12, wherein the previous electronic communications were sent or received by other computing devices while the other computing devices were located at a current location of the computing device.

14. The method of claim 10, wherein the local model is a first local model, the method further comprising:
responsive to determining a change in the current location of the computing device from a first location to a second location:
obtaining, by the keyboard application, from a remote computing system, a second model of searchable phrases of iconographic symbols, the second model being associated with the second location; and
replacing, by the keyboard application, the first local model with the second model.

15. A computing device comprising:
a presence-sensitive display component;
at least one processor; and
a memory that stores instructions associated with a keyboard application that, when executed, cause the at least one processor to:
output, for display at the presence-sensitive display component, a graphical keyboard comprising a plurality of keys;
determine, based at least in part on an indication of a selection of one or more keys from the plurality of keys, text of an electronic communication;
determine, based at least in part on the text, an implied user-expression that characterizes at least a portion of the text;
generate, a phrase of one or more iconographic symbols that represent the implied user-expression; and
output, for display within the graphical keyboard, a graphical indication of the phrase.

16. The computing device of claim 15, wherein the instructions, when executed, cause the at least one processor to determine the implied user-expression in response to determining an end of the text of the electronic communication.

17. The computing device of claim 15, wherein the keyboard application executes as a keyboard extension of a different application.

18. The computing device of claim 15, wherein the instructions, when executed, further cause the at least one processor to:
determine, based on the implied-user expression and from a local model of searchable phrases of iconographic symbols, a score assigned to a particular phrase of iconographic symbols indicating a probability that the particular phrase of iconographic symbols is relevant to the implied user expression;
responsive to determining the score assigned to the particular phrase of iconographic symbols satisfies a threshold, identify the particular phrase of iconographic symbols as the phrase of one or more iconographic symbols.

19. A computer-readable storage medium comprising instructions that when executed cause at least one processor of a computing device to:
output, for display, a graphical keyboard comprising a plurality of keys;
determine, based at least in part on an indication of a selection of one or more keys from the plurality of keys, text of an electronic communication;
determine, based at least in part on the text, an implied user-expression that characterizes at least a portion of the text;
generate, a phrase of one or more iconographic symbols that represent the implied user-expression; and
output, for display within the graphical keyboard, a graphical indication of the phrase.

20. The computer-readable storage medium of claim 19, wherein the instructions, when executed, further cause the at least one processor to responsive to receiving an indication of a selection of the graphical indication of the phrase, output, as part of the electronic communication, the phrase of one or more iconographic symbols.
